(19) United States
(12) Patent Application Publication
(10) Pub. No.: US 2001/0034680 A1
(43) Pub. Date: Oct. 25, 2001

(54) System and method for online delivery of investor documents and tabulation and processing certain investor instructions

(75) Inventor: John Purcell, Darien, CT (US)

Correspondence Address: MORGAN, LEWIS & BOCKIUS, 1800 M STREET NW, WASHINGTON, DC, 20036-5869, US

(73) Assignee: Mediant Communications Inc.

(21) Appl. No.: 09/760,745

(22) Filed: Jan. 17, 2001

Related U.S. Application Data
(60) Provisional application No. 60/197,602, filed on Apr. 18, 2000.

(51) Int. Cl. G06F 17/60; G06F 15/16

(52) U.S. Cl. 705/35; 709/217; 709/218; 709/219; 705/7

(57) ABSTRACT

A system for online delivery of documents to Investors, and for receiving voting or tendering instructions from investors including an E-broker system with a database that sends information to and receives information from an Investor through an investor system. The system also includes an electronic dissemination and tabulation system (“EDT”) for securely delivering information directly to or receiving information directly from the investor system in response to an Investor request sent via the E-broker system. Furthermore, the EDT system sends information to the investor system in correspondence to stock holdings of the Investor as recorded in the E-broker system.

### FIELD OF THE INVENTION

The present invention relates to a system and method for delivering public companies' disclosure materials online and tabulating and processing certain investor instructions relating thereto, and particularly, for distributing such materials online to shareholders who previously availed themselves of online contact.

### BACKGROUND OF THE INVENTION

Advances in computer processing power and network communications have made information from a wide variety of sources available to users on computer networks. Computer networking allows network computer users to share information, software applications and hardware devices and internetworking enables a set of physical networks to be connected into a single network such as the Internet. Today, computers connected to the Internet have almost instant access to information stored in relatively distant regions. Moreover, computers connected to networks other than the Internet also have access to information stored on those networks. The World Wide Web (Web), a hypermedia system used on the Internet, enables hypertext linking, whereby documents automatically reference or link other documents located on connected computer networks around the world. Thus, users connected to the Internet have almost instant access to information stored in relatively distant regions.

A page of information on the Web may include references to other Web pages and may include a broad range of multimedia data including textual, graphical, audio, and animation information. Currently, Internet users retrieve information from the Internet, through the Web, by “visiting” a web site on a computer that is connected to the Internet.

The web site is, in general terms, a server application that displays information stored on a network server computer. The web site accepts connections from client programs, such as Internet browser applications. Browser applications, such as Microsoft Explorer™ or Netscape Navigator™, allow Internet users to access information displayed on the web site. Most browser applications display information on computer screens and permit a user to navigate through the Web using a mouse. Like other network applications, Web browsing uses the client-server paradigm. When given the Uniform Resource Locator (URL) of a document, the browser application becomes a client and it contacts a server application specified in the URL to request the document. After receiving the document from the server application, the browser application displays the document for the user. When the browser application interacts with the server application, the two applications follow the HyperText Transport Protocol (HTTP). HTTP allows the browser application to request a specific article, which the server application then returns. To ensure that browser applications and server applications inter-operate unambiguously, HTTP defines the exact format for requests sent from the browser application to the server application as well as the format of replies that the server application returns.

Each year, public companies mail to their investors various sets of disclosure documents, including annual reports, proxy statements, tender/exchange offer documents and interim or other miscellaneous mailings. In the United States, all corporations, otherwise known as Issuers of securities, are required under state law to hold shareholder meetings at least annually. Public corporations are required under applicable stock exchange regulations to solicit proxies in connection with those shareholder meetings. Federal securities laws require that anyone soliciting proxies from shareholders of a publicly-traded company must first deliver a definitive proxy statement. Moreover, if there is an annual meeting, the company must deliver its annual report. With these overlapping regulations, public issuers are required to deliver annual reports and proxy statements at least annually, and there are a number of other situations in which mailings are legally required, such as special meetings, consent solicitations, and tender or exchange offers. In addition, public companies also voluntarily disseminate additional documents, such as quarterly reports, to their shareholders.

Because public companies do not know the identities of their shareholders whose shares are held in the name of a bank or broker custodian, those bank and broker custodians are required by law to forward these public company mailings on to their customers. Currently, the vast majority of banks and brokers outsource this function to one or more agents (“Custodian Agents”). When an issuer has a mailing, it notifies the Custodian Agents and they electronically capture the Investor account information from their bank and broker clients. The Custodian Agents report back the number of sets of disclosure documents they will need, and upon delivery of those sets from the Issuer, mail the materials to the Investors. When shareholder action is required, the Custodian Agents receive and process those instructions and deliver the tabulated instructions to the appropriate party. For example, Custodian Agents collect voting instructions from the Investors for a shareholder meeting and deliver a single “master proxy” to the Issuer representing all the shares held in their customers' accounts that voted.

The current system has been the subject of criticism among market participants, corporations, and regulators. A comprehensive electronic delivery mechanism could save public companies billions of dollars annually in paper, printing and postage costs, and would likely spur more frequent communications between public companies and their shareholders.

### SUMMARY OF THE INVENTION

Accordingly, the present invention is directed to the online delivery of investor materials and tabulation of related instructions that substantially obviates one or more problems due to limitations and disadvantages of the prior art.

It is an object of the present invention to provide a system and method for providing issuer's disclosure and other materials online, and particularly, annual reports and meeting notices.

It is another object of the invention to provide a system and method for delivering a means by which Investors can submit share voting or voluntary reorganization instructions online, and for receiving and processing votes and voluntary reorganization instructions.

It is another object of the invention to provide a system that can be seamlessly and securely integrated into a third party's web site, allowing the system operator to remotely administer the online delivery of materials to specific parties which have been authenticated into the third party's website, and to process related instructions, without such specific parties having to leave the third party's website.

Additional features and advantages of the invention will be set forth in the description that follows, and in part will be apparent from the description, or may be learned by practice of the invention. The objectives and advantages of the invention will be realized and attained by the system particularly pointed out in the written description hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 illustrates a computer network in which the inventive system may be incorporated.

FIG. 2 illustrates the TCP/IP Layering Model Protocol used during communications between components on the computer network.

FIG. 3 illustrates the general interaction of various parties' systems in the inventive system.

FIGS. 4a and 4b generally illustrates the inventive system's method for annual or special meeting mailings and consent solicitations.

FIGS. 5a and 5b generally illustrates the inventive system's method for a tender/exchange offer.

### DESCRIPTION OF THE PREFERRED EMBODIMENTS

Reference will now be made in detail to the preferred embodiments of the present invention, examples of which are illustrated in the accompanying drawings. The present invention described below extends the functionality of the inventive system and method for determining the on-line presence for registered Investors of the inventive system.

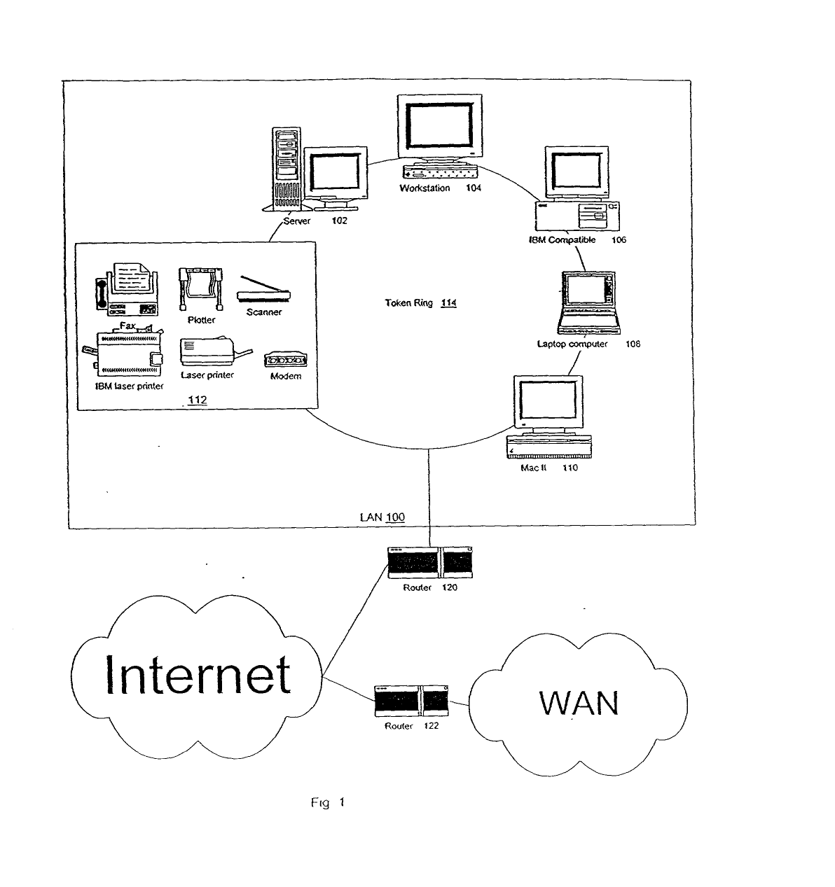

FIG. 1 is an example of a local area network (LAN) 100 that is configured to utilize the inventive system. LAN 100 comprises a server 102, four computer systems 104-110, and peripherals, such as printers and other devices 112 that may be shared by components on LAN 100. Computer systems 104-110 may serve as clients for server 102 and/or as clients and/or servers for each other and/or for other components connected to LAN 100. Components on LAN 100 are preferably connected together by cable media, for example copper or fiber-optic cable and the network topology may be a token ring topology 114. It should be apparent to those of ordinary skill in the art that other media, for example, wireless media, such as optical and radio frequency, may also connect LAN 100 components. It should also be apparent that other network topologies, such as Ethernet, may be used.

Data may be transferred between components on LAN 100 in packets, i.e., blocks of data that are individually transmitted over LAN 100. Routers 120, 122 create an expanded network by connecting LAN 100 to other computer networks, such as the Internet, other LANs or Wide Area Networks (WAN). Routers are hardware devices that may include a conventional processor, memory, and separate I/O interface for each network to which it connects. Hence, components on the expanded network may share information and services with each other. In order for communications to occur between components of physically connected networks, all components on the expanded network and the routers that connect them must adhere to a standard protocol. Computer networks connected to the Internet and to other networks typically use TCP/IP Layering Model Protocol. It should be noted that other internetworking protocols may be used.

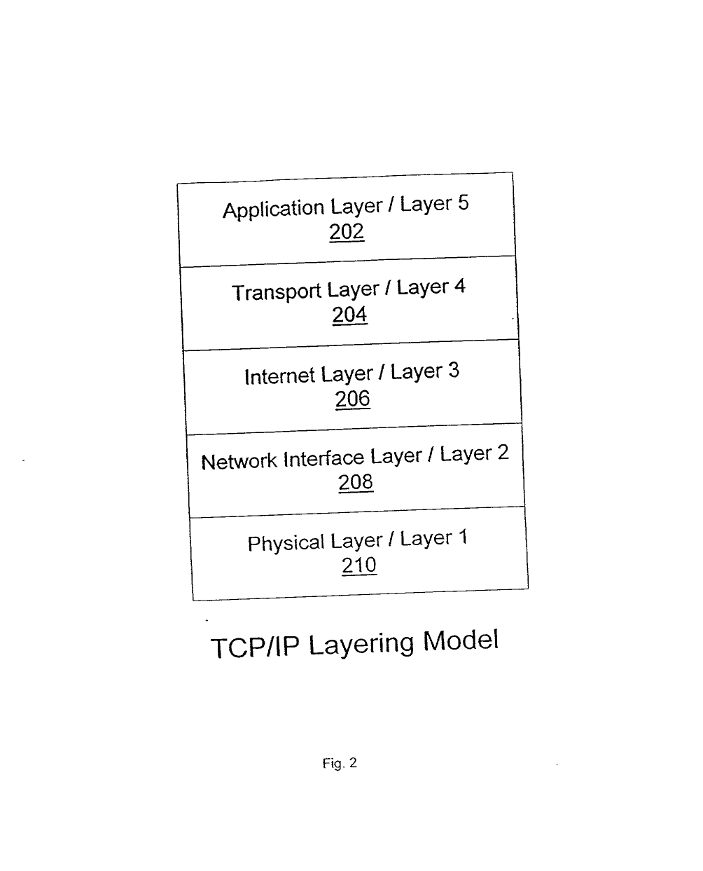

As illustrated in FIG. 2, TCP/IP Layering Model comprises an application layer (Layer 5) 202, a transport layer (Layer 4) 204, an Internet layer (Layer 3) 206, a network interface layer (Layer 2) 208, and a physical layer (Layer 1) 210. Application layer protocols 202 specify how each software application connected to the network uses the network. Transport layer protocols 204 specify how to ensure reliable transfer among complex protocols. Internet layer protocols 206 specify the format of packets sent across the network as well as mechanisms used to forward packets from a computer through one or more routers to a final destination. Network interface layer protocols 208 specify how to organize data into frames and how a computer transmits frames over the network. Physical layer protocols 210 correspond to the basic network hardware. By using TCP/IP Layering model protocols, any component connected to the network can communicate with any other component connected directly or indirectly to one of the attached networks.

The preferred embodiment of the present invention will now be described. For purposes of this discussion, the inventive system is referred to as Electronic Dissemination and Tabulation (“EDT”). Brokerage firms or agents thereof, which are clients of the EDT system, have a database that contains information on their respective Investor clients. This information typically includes the name of the Investor associated with other information about the Investor, such as account number, street address, social security number, e-mail address, telephone number and the securities held in the portfolio of the Investor at any given time. Particular information with regard to the portfolio of an Investor that a client Broker's database contains includes the names of Issuers and the number of securities in an Issuer (i.e. stock) that an Investor holds through that Broker. Also, for each specific security held by the Investor, a Broker's database contains information as to whether the Investor has indicated whether they object to the Broker disclosing the Investor's identity and holdings (i.e., Objection Beneficial Owner, “OBO”, or Non-Objecting Beneficial Owner, “NOBO”) to the Issuer of that security.

Most Brokerage firms have websites affiliated with their broker systems, as well as direct connection hook-ups for Investors to trade investments online. These types of Brokers are considered to be E-Brokers since they enable investment trading on-line. Typically, the database of a broker system is affiliated with the E-broker's website for recording the transactions of their Investor's online activities. An Investor may hold an Issuer's securities through several E-brokerage firms that are clients of the EDT system and thus be listed in several E-broker databases that the inventive system can access.

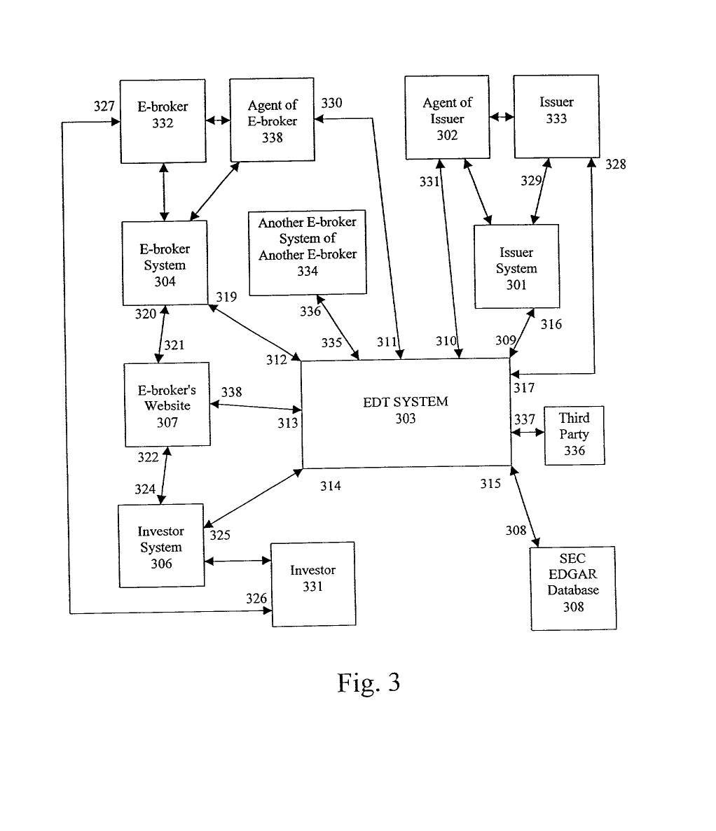

As depicted in FIG. 3, the inventive system begins with an Issuer 333, or an agent thereof, informing the EDT System 303 of an impending “event” and certain information relating thereto 310/317. The EDT system 303 can be informed by electronic means 310/317 by issuers or their agents 333, 302, respectively, and/or, by other secure electronic communications 337 including third-party data providers 336, or by writing that is then manually entered into to the EDT system 303. The “event” may be an Issuer's meeting of stockholders, consent solicitation, tender/exchange offer, or other event which requires the Issuer 333 to deliver information to its Investors 331, or may simply be a mailing from an Issuer to its Investors, such as a quarterly report.

The EDT system 303 generates an “event profile” that includes the “event” with all other pertinent information. The pertinent information may include the digital documents relating to the “event”, which may be electronically captured 315 from the EDGAR database 308 or manually retrieved from the Issuer or its agent 310/317 and input into the EDT system 303. Other examples of pertinent information are press releases, government reports or news stories. The documents and “electronic instruction forms” (through which Investors transmit voting or tender/exchange instructions) relating to the “event” are placed in an “electronic envelope.” The “electronic envelope” is stored locally in the EDT database.

The EDT system 303 then queries 319/336 all client E-broker systems 304/334 to electronically capture 311/312/335 in the EDT system's 303 database the account number, number of shares, name and address (including an e-mail address), and NOBO/OBO status of all Investors 331 in the EDT system's 303 client E-brokers systems 304 /334 that hold an interest in the Issuer 333 on the relevant date relating to the event. In the system of FIG. 3, the E-broker system 334 does not contain any Investors holding an interest in the Issuer's event. Therefore, the EDT system 303 will no longer interact with the second E-broker system 334 since there are no Investors in the Issuer 333 on the relevant date relating to the event. Furthermore, the EDT system 303 determines which customers of the client E-broker systems 304 of the EDT system 303 will receive the “electronic envelope.”

After the EDT system 303 generates the “electronic envelopes” with, where applicable, the appropriate “electronic instruction forms” for Investors within the client E-Broker systems that hold the Issuer's securities, the EDT system 303 “notifies” the Investors via e-mail 325 that documents pertaining to the particular event from a particular Issuer 333 are available. The e-mail notification instructs the Investor 322 to go to the E-broker's website using an embedded URL 307, and to log into the E-broker's system using the Investor's normal username and password 304. Once authenticated by the E-broker's system 304, the E-broker's system 304 spontaneously communicates with the EDT system over a secure socket layer, requesting that the EDT system retrieve and present in XML format all “electronic envelopes” to which the Investor is currently entitled 312/313. This same secure communication between the E-broker's system 304 and the EDT system 303 can be triggered by the Investor 331 clicking on an icon on the E-broker's site 307 which links the Investor to the Investor's mailbox 312/313.

The Investor system 306 can be a personal computer such as laptop, home PC or any other equivalent (e.g. Palm Pilot™, Internet cell phone, etc.). The Investor system 306 is not necessarily the Investor's own computer or access device, but any electronic device used to access and interact with the E-broker's website 307. While the Investor is interacting with the E-broker's website 307, the Investor can pull up 313 their “Investor Mailbox” 313 by clicking on a mail icon. Once the Investor pulls up the “Investor Mailbox”, the “Investor Mailbox” is administered 319/338 from the EDT system 303 and securely connected 322/324 to the Investor system 306 via the E-broker website.

When the Investor clicks on the “Investor Mailbox” icon, the E-broker system 304 has already identified the Investor through the E-broker system's 304 security access protocols 320 (i.e. passwords, encrypted cookies, etc.). Thus, the Investor does not have to utilize a separate control number or password; the Investor's name and password used to log into the E-brokerage account on the E-broker website 307 is all that is needed.

The “Investor Mailbox” contains all “electronic envelopes” that relate to securities in the Investor's portfolio that have active mailings, which are in the client E-Broker system of the EDT system. Each specific Issuer will have the “electronic envelope” with the “event profile” that has the Issuer's name, the event date(s), and documents. Furthermore, the “electronic envelope” may contain an “electronic instruction form” to enable the Investor to respond, where applicable, to Issuer mailings (i.e., for a tender/exchange, consent solicitation, and/or voting). Each document is available in a variety of formats that can be printed locally, including portable document format (“PDF”), HTML, and/or ASCII. The EDT system 303 maintains the documents in the “Investor Mailbox” through the applicable event date.

The EDT system remotely tracks the delivery of the e-mail notification to the Investor 314, the Investor's opening of the e-mail and clicking of the embedded URL 314, and the delivery of “electronic envelopes” to the Investor at the Investor's E-broker site 313. The EDT system also records and date stamps an electronic record that the Investor clicked 312 on the “Investor Mailbox” icon located at the E-broker's website. These records of accesses by the Investor can be forwarded 331 to the Issuer 333, or the agent 302 thereof. In addition to recording and confirming an Investor viewing certain information, the EDT system 303 confirms delivery to an Investor's e-mail server of an electronic notification to the Investor of an Issuer's event by sending electronic return receipt 314 of the e-mail or its equivalent.

If an action is required, such as voting or tendering shares, an interactive electronic instruction form is displayed. For a voting instruction form pertaining to a proxy solicitation, the Investor can click 322 choices for each proposal and submit the vote. A confirmation can be automatically generated and sent back 325 to the Investor's e-mail account. If the instruction form pertains to a tender offer, the Investor can click 322 to confirm the desire to tender an Investor's shares into an offer.

The entire process (including shareholder voting/tender instructions) is captured in the EDT system's databases, time-stamped, and recorded 313. Voting instructions are tabulated and a master proxy for the client E-broker is sent to the Issuer system 328 or the agent 331 of the issuer immediately prior to the shareholder meeting. Tender/exchange instructions are tabulated and delivered 319/330 to the client E-broker system 304, or to the agent 305 thereof by Investor account number allowing the E-broker 332 to tender the appropriate number of shares into an offer.

### ANNUAL/SPECIAL MEETING MAILINGS/VOTING

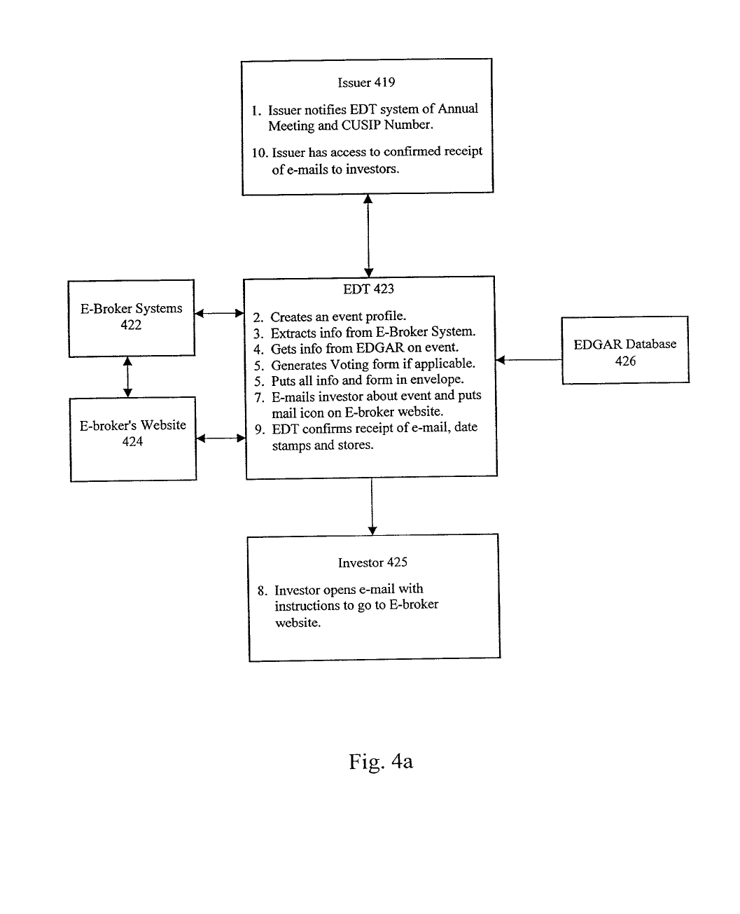

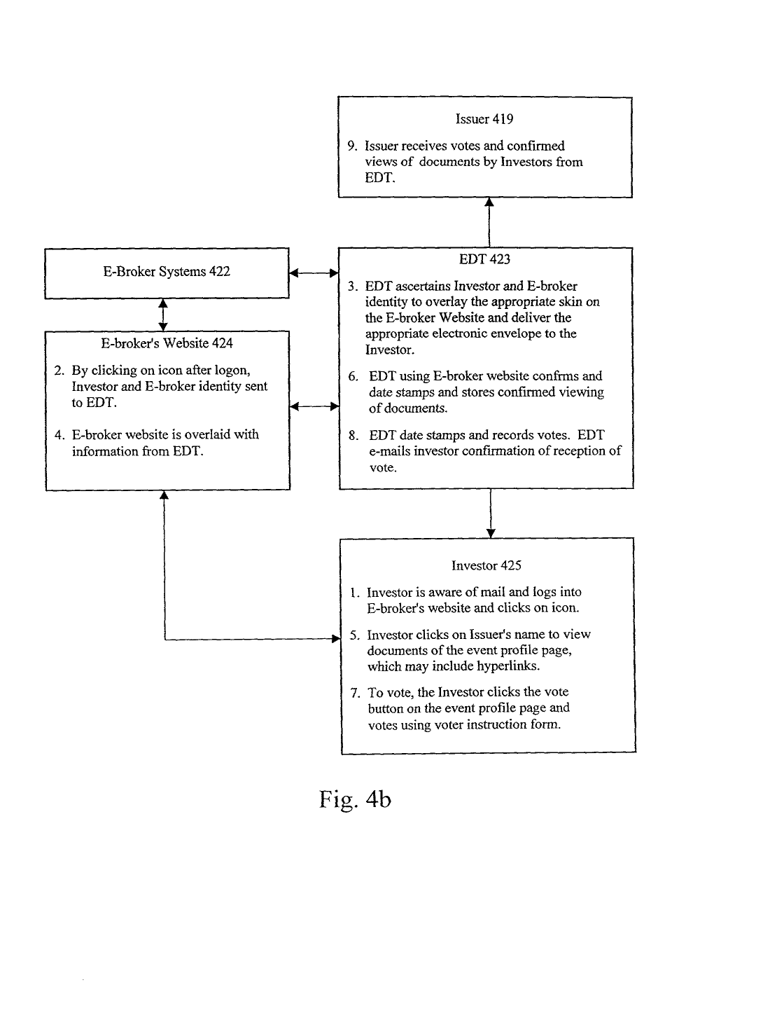

FIG. 4a illustrates the inventive system's method for gathering information and notifying an Investor of an annual or special meeting mailings and consent solicitations. Issuer 419, or an agent thereof, or a third-party data provider, sends to the EDT system 423 information pertaining to an upcoming event, including record, mailing and meeting dates, as well as affected CUSIP number(s), which is a unique nine-character identification for each class of security approved for trading in the United States, to facilitate clearing and settlement. The EDT system 423 then creates an event profile with a unique identifier. The EDT system 423 extracts via a secure connection from the client E-broker systems 422 with respect to each qualifying Investor the (i) names and addresses, (ii) NOBO/OBO status, (iii) share amounts, (iv) E-brokerage account numbers, (v) e-mail address and (vi) E-brokers' identities. Other necessary information to be extracted will be known to those skilled in the art, and are within the scope of the present invention.

After the above information is gathered from the E-broker systems 422, the EDT system 423 procures documents in electronic format from Issuer 419 or its agent thereof, and downloads any applicable filings of the Issuer contained in the Electronic Data Gathering, Analysis, and Retrieval (EDGAR) electronic filing system (ARS, 10-K, 14A) from the Securities Exchange Commission (“SEC”) or its agent. These documents are available in PDF, HTML and text or ASCII formats. Other formats will be known to those skilled in the art, and are within the scope of the present invention. Investors 425 will be presented with the documents in all available formats and will have a choice regarding which format they would like to view the documents.

If necessary, the EDT system 423 creates an online voting instruction form (VIF) using the Issuer's actual proxy card, and confirms the accuracy of the VIF with Issuer 419 or its agent. The EDT system 423 will confirm whether proposals are considered routine or nonroutine under NYSE broker discretionary voting rules. VIFs can include hyperlinks from the text of the proposal on the VIF to the text in the proxy statement discussing that proposal. It might also include a limited comment box for Investors 425 wishing to deliver messages directly to management. Other options will be known to those skilled in the art, and are within the scope of the present invention. The VIF would give the Investor 425 two options: click a single button and an Investor's shares will automatically be voted in accordance with management's recommendations or manually fill out the card and submit it. The EDT system 423 then stores the electronic documents and voting instruction form in an “electronic envelope”.

As shown in FIG. 4a, after the gathering of the information on the notification date, the EDT system 423 automatically generates a personalized e-mail notice to the Investor 425 notifying the Investor that electronic materials pertaining to the event are now available at the Investor's E-broker site. The e-mail instructs the Investor to go to the E-broker's website 424 [or to logon to the EDT system] to retrieve the Issuer's documents. The e-mails are sent with a return receipt or its equivalent in order to confirm that the intended recipients received the e-mails. The return receipts or their equivalent are date stamped and stored by the EDT system so that the return receipts or their equivalent later can be forwarded to the Issuer.

The EDT system 423 requires its E-broker client websites 424 to include an “Investor Mailbox” icon on the screen that contains the Investor's account information (i.e., after the Investor has logged in). The icon will notify the EDT system that a particular Investor wishes to review documents pertaining to the Investor's account, and the EDT system will retrieve such documents and stream them in XML format back to the E-broker's website to be displayed to the Investor. This is the extent of EDT system's 423 infiltration into the client E-broker's website 424. Thus, the EDT system 423 is minimally invasive to the client E-broker's website 424 from the E-broker's standpoint.

FIG. 4b general illustrates the inventive system's method for an Investor to view information and/or vote. When the Investor 425 is aware of an event or is checking for events, the Investor 425 logs onto the online E-broker's website 424 and sees a mail alert (e.g., mailbox arm in the air or some other alert notice given in coordination with online E-broker). The EDT system 423 electronically interacts with the E-broker's website 424 to ensure that the alert occurs.

To access the event information, access the electronic documents, or vote, the Investor 425 clicks on an “Investor Mailbox” icon. By clicking on the icon after logging on, the Investor 425 transmits to the EDT system 423 an encrypted file, which the EDT system 423 decodes to ascertain the Investor's account number and the referring client E-broker's 422 identity. The account number is used to pull up the appropriate event profiles containing the data to be streamed into the client E-broker's website 424. The EDT system seamlessly and securely integrated into the client E-broker's website, allowing the EDT system to remotely administer the online delivery of materials to specific Investors which have been authenticated into the E-broker's website, and to process related instructions, without the Investors to leave the E-broker's website.

The first screen in the “Investor Mailbox” welcomes the Investor 425 and sets forth the issuers 419 who electronically delivered documents to the Investor 425, the date(s) those documents were delivered, an indicator of whether the Investor 425 has reviewed those documents and voted already, the event to which the documents pertain (e.g. Annual Meeting), and other relevant information.

The Investor 425 clicks on an issuer's name to review its documents or vote the shares. This brings up the second screen, which is the Event Profile. The Event Profile screen contains the Issuer's name and perhaps the corporate logo of the issuer, hyperlinks to the electronic documents (in a variety of formats—see above), an indication of whether the Investor 425 has voted in the past (Voted/Unvoted) with the option to have the Investor's previous voting instructions e-mailed to an Investor 425, and a voting instruction form. The EDT system 423 may include an icon to allow the Investor to participate at the meeting via streaming video if the issuer system makes it available, and may include the option to purchase/view proxy voting recommendation reports from a third-party vendor. Other options will be known to those skilled in the art, and are within the scope of the present invention.

As shown in FIG. 4b, the voting instruction form sets forth all of the proposals and management's (or other sender's) recommendation on how to vote. The Investor 425 is given the option to click a single button to vote shares as per management's recommendation, or to complete the VIF one proposal at a time.

In another embodiment, EDT hyperlinks the proposals to the discussion of the proposals in the text of the proxy statement. The EDT system may provide a graphic depiction of how all other Investors have voted to date. Upon submission of a vote, an e-mail confirming receipt of the Investor's vote and perhaps how the Investor voted can be sent to the Investor's e-mail address.

The EDT system records time and date each Investor visits the “Investor Mailbox”. The database of the EDT system also will track an Investor's accessing to Event Profiles, as well as time and date stamp the voting instructions to ensure that only the latest dated instructions are counted.

The EDT 423 system can provide a variety of additional information to the Issuer, including non-objecting Investor tapes, share range analyses, geographic breakdown analyses, reminder e-mails, and legal proxies. Furthermore, the EDT system 423 has a password-encrypted issuer 419 status screen that enables the issuer 419 or its agent, to remotely monitor the progress of the solicitation, and to order additional services (see previous point). Lastly, the EDT system 423 can generate a master proxy on behalf of the E-broker client 419 and deliver it to the Issuer 419 by fax or e-mail in time for the meeting.

### TENDER/EXCHANGE OFFER

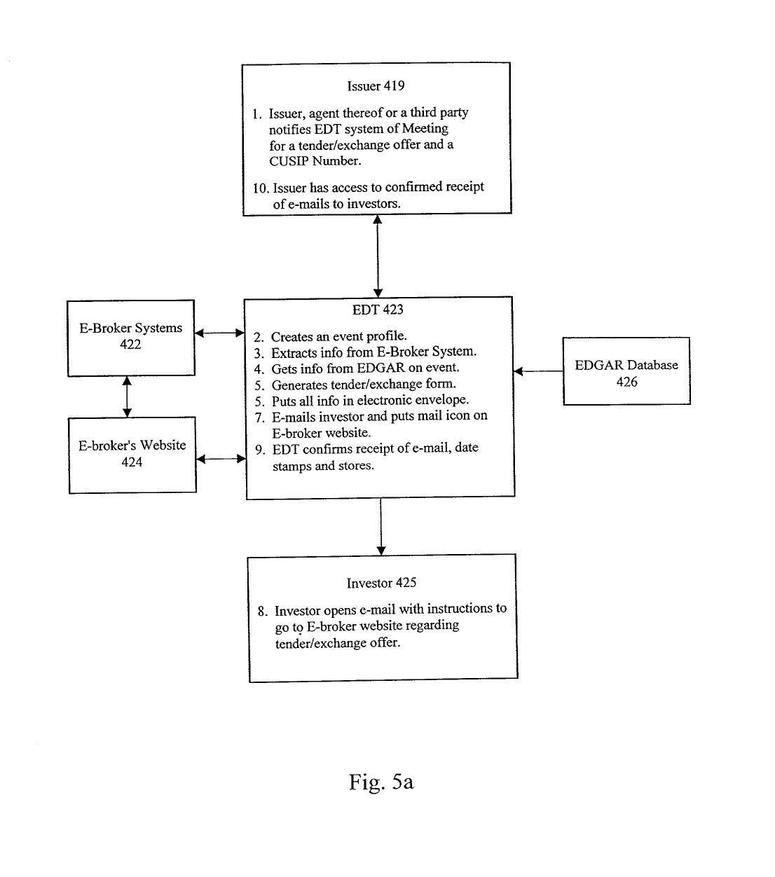

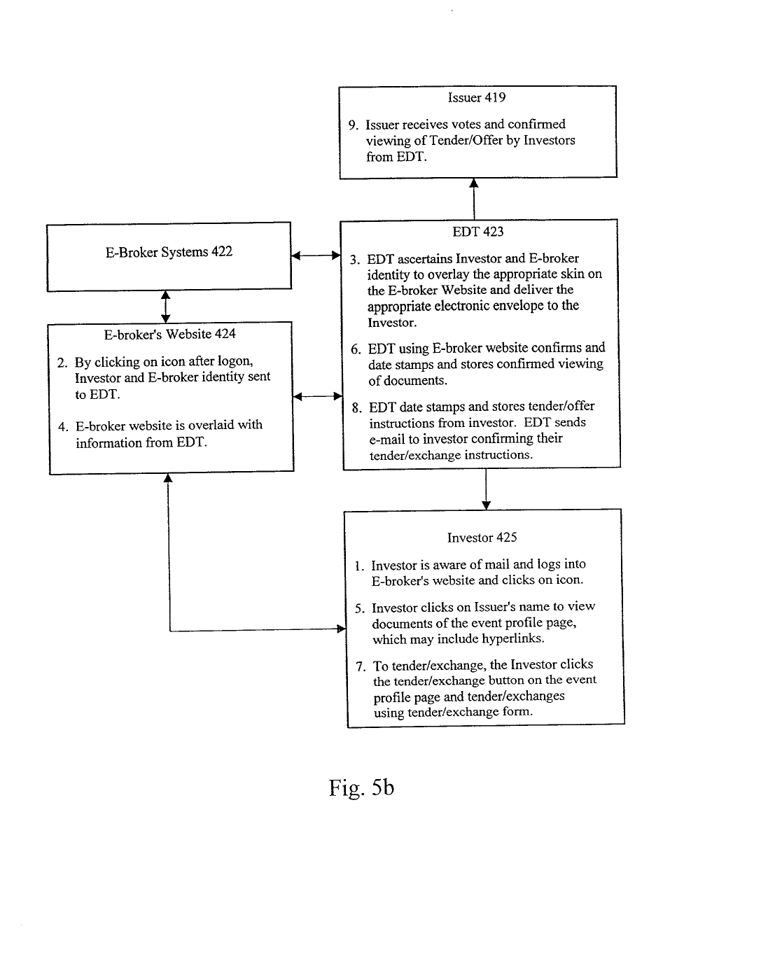

FIG. 5a generally illustrates the inventive system's method for gathering information for, and notifying an Investor of, a Tender/Exchange offer. The first step is that an Issuer 419, or an agent thereof, or a third-party data provider, sends to the EDT system 423 information pertaining to an upcoming event, including record, mailing and meeting dates, as well as affected CUSIP number(s), which is a unique nine-character identification for each class of security approved for trading in the United States, to facilitate clearing and settlement of a Tender/Exchange offer. The EDT system 423 then creates an event profile with a unique identifier. The EDT system 423 extracts via a secure connection from the client E-broker systems 422 with respect to each qualifying Investor the (i) names and addresses, (ii) NOBO/OBO status, (iii) share amounts, (iv) E-brokerage account numbers, (v) e-mail address and (vi) E-brokers' identities. This information is updated daily during the effectiveness of the reorganization event to monitor changes in security positions during such event, and new Investors are sent notifications via the EDT system. Other necessary information to be extracted will be known to those skilled in the art, and are within the scope of the present invention.

The EDT system procures documents in electronic format from the issuer or its agent, and downloads the issuer's Electronic Data Gathering, Analysis, and Retrieval (EDGAR) filings (offer documents) into local cache. The documents are available in PDF, HTML and text or ASCII formats. The Investor will have a choice regarding which format he would like to view the documents.

Then the EDT system creates on online tender/exchange instruction form (TEIF). TEIF may include a limited comment box for Investors 425 wishing to deliver messages directly to offeror. In a preferred embodiment, the TEIF gives the Investor 425 two options: click a single button and the Investor's shares will automatically be tendered in accordance with management's recommendations or manually fill out the card and submit it. Then the EDT system 423 stores the electronic documents and TEIF in an electronic “envelope”.

On the mailing date, and each day during the effective period of the reorganization event, the inventive system automatically generates a personalized e-mail notice to the Investor 425 notifying the Investor 425 of the tender/exchange offer. The e-mail instructs the Investor to go to an E-broker's website 424 or to log on to the EDT system to retrieve the Issuer's documents on the tender/exchange offer and respond. The e-mails are sent with a return receipt in order to confirm that the intended recipients received the e-mails. The return receipts are date stamped and stored by the EDT system so that the return receipts can later be forwarded to the Issuer or the agent thereof.

The EDT system 423 will require its E-broker client websites 424 to include an “Investor Mailbox” icon on the screen that contains the Investor's account information (i.e., after he has logged in). The icon will take the Investor 425 via a secure connection to EDT's website when he wishes to review documents and tender/exchange.

As shown in FIG. 5b, in order for an Investor 425 to access the inventive system 423, the Investor 425 logs onto the online E-broker's website 424 and sees that mail is available (the display shows a mailbox arm in the air, or an alert notice is given). The EDT system electronically interacts with the E-broker's website 424 to ensure that the alert occurs.

The Investor 425 clicks on the “Investor Mailbox” icon to access the electronic documents and give instructions to tender/exchange shares. By clicking on the icon after logging on, the Investor 425 transmits to the EDT system 423 an encrypted file, which the EDT system 423 decodes to ascertain the Investor's account number and the referring client E-broker's 422 identity. The account number is used to pull up the appropriate event profiles containing the data to be streamed into the client E-broker's website 424. This mechanism eliminates the current requirement that the Investor 425 separately input a unique company number and control number.

The first screen in the “Investor Mailbox” welcomes the Investor and displays the Issuers that have electronically delivered documents to the Investor, the date(s) those documents were delivered, an indicator of whether the Investor has reviewed those documents and given tender/exchange instructions already, the event to which the documents pertain (e.g., tender or exchange offer) and any other relevant information.

The Investor chooses an Event by clicking on the appropriate icon and this brings up the second screen, which is the Event Profile. The Event Profile screen sets forth the Issuer's name and perhaps the corporate logo of the Issuer, hyperlinks to the electronic documents (in a variety of formats—see above), an indication of whether the Investor has already given tender/exchange instructions in the past with the option to have the previous instructions e-mailed to an Investor 425, and a tender/exchange instruction form screen.

The Investor clicks on the Tender/Exchange button to access the tender/exchange instruction form. This brings up a new screen that includes a “legalistic” statement in which the Investor 425 instructs that the Investor's shares be tendered/exchanged in connection with the offer. Upon submission of an Investor's instructions, an e-mail confirming receipt of the Investor's instructions will be sent to the Investor's e-mail address. The EDT system 423 records the time and date of the Investor viewing each “event” when the Investor visits the “Investor Mailbox”. The EDT system 423 tracks the Investor's access to Event Profiles and time and date stamp the Investor's tender/exchange instructions to ensure that only the latest dated instructions are counted.

The EDT system 423 may incorporate a feature into the “Investor Mailbox” that enables the Investor to input the Investor's telephone number and that will enable EDT representatives to 5 call directly to answer the Investor's questions or assist an Investor through TeleTender. EDT can provide NOBO tapes, share range analyses, geographic breakdown analyses, and reminder e-mails. To the extent legally permissible, the EDT system also will provide TeleTender services where EDT calls the Investor to confirm receipt of offer materials and to gather the Investor's voice instructions directly over the phone. This feature also enables the EDT system 423 to remotely access the Investor's browser to further assist an Investor in the review and tender/exchange process.

The EDT system 423 has a password-encrypted issuer status screen, which will enable the issuer 419 or its agent to remotely monitor the progress of the solicitation, and to order additional services. For example, the EDT system 423 generates a master tender/exchange instruction form on behalf of each client E-broker 422 and delivers it to the issuer 419 by fax or e-mail in time for the expiration of the offer.

The foregoing description has been directed to specific embodiments of this invention. It will be apparent, however, that other variations and modifications may be made to the described embodiments, with the attainment of some or all of their advantages.

What is claimed is:

1. A system for online delivery of documents to Investors, and for receiving voting or tendering instructions from investors comprising:
an E-broker system with a database that sends information to and receives information from an Investor through an investor system;
an electronic dissemination and tabulation system (“EDT”) for delivering information to or receiving information from the investor system in response to an investor system request sent via the E-broker system; and
wherein the EDT system sends information to the investor system in correspondence to stock holdings of the Investor as recorded in the E-broker system.

2. The system of claim 1, wherein an electronic indication notifies the Investor that information is available or information is requested from either the EDT system or the E-broker system.

3. The system of claim 1, wherein the communication between the EDT, E-broker, and investor systems use a layering model protocol including at least an application layer, a transport layer an Internet layer, a network interface layer and a physical layer.

4. The system of claim 1 wherein, the investor system request results from a click on an icon on a website of the E-broker system.

5. The system of claim 1, wherein the electronic dissemination and tabulation system provides information by hyperlinked text.

6. The system of claim 1, wherein other E-broker systems in addition to the E-broker system inform the EDT system of what information can be sent to or received from the investor system by record keeping of online activities of Investors in each respective E-broker system.

7. The system of claim 1, wherein the electronic dissemination and tabulation system provides information that includes streaming video.

8. A system for online delivery of documents to Investors, and for receiving voting or tendering instructions from Investors comprising:
an investor system for an Investor to send and receive information;
an E-broker system, having a website, that sends information to and receives information from an investor system;
an electronic dissemination and tabulation system for delivery of information to or reception of information from the investor system; and
wherein the website enables the electronic dissemination and tabulation system to send information to or receive information from the investor system in correspondence to stock holdings of the Investor as recorded in the E-broker system.

9. The system of claim 8, wherein the investor system is e-mailed notification that information is available on or information is requested by the electronic dissemination and tabulation system.

10. The system of claim 8, wherein the communication between the issuer, electronic dissemination and tabulation, E-broker, and investor systems uses a layering model protocol including at least an application layer, a transport layer an Internet layer, a network interface layer and a physical layer.

11. The system of claim 8, wherein a single click in an area of the website by the Investor enables the electronic dissemination and tabulation system to send information to the investor system.

12. The system of claim 8, wherein the E-broker system provides information to the electronic dissemination and tabulation system of what information can be sent to or received from the investor system through record keeping of activities of the Investor on the E-broker system.

13. The system of claim 12, wherein other E-broker systems in addition to the E-broker system provide information to the electronic dissemination and tabulation system of what information can be sent to or received from the investor system by record keeping of online activities of all Investors on each respective E-broker system.

14. A method for online information gathering from Investors comprising the aspects of:
an Issuer of investment securities, or an agent thereof, notifying an electronic dissemination and tabulation system of an event requiring information from Investors of the Issuer who trade on-line with at least one E-broker system; and
the Investors connecting to the electronic dissemination and tabulation system via a website of the at least one E-broker system for information from the Issuer.

15. The method of claim 14, wherein the Investor can only connect via a website of the at least one E-broker system to the electronic dissemination and tabulation system where the Investor bought investment securities of the Issuer through the at least one E-broker system.

16. The method of claim 14, wherein the electronic dissemination and tabulation system e-mails the Investor to inform the Investor of the event.

17. The method of claim 14, wherein the electronic dissemination and tabulation provider searches more than one E-broker system to determine the Investors of the Issuer who trade investments on-line.

18. A method for online delivery of documents to Investors and for receiving voting instructions from Investors comprising the aspects of:
an Issuer of investment securities, an agent thereof or a third party, notifying an electronic dissemination and tabulation provider of an event requiring the dissemination of information or a vote of Investors of the issuer by electronic means;
the electronic dissemination and tabulation provider capturing data from at least one E-broker system on the Investors of the Issuer;
the Investors of the Issuer using an investor system to connect to the electronic dissemination and tabulation system to vote via the E-broker system.

19. The method of claim 18, wherein the Investors securely connect to the electronic dissemination and tabulation system from a website of the E-broker system.

20. The method of claim 18, wherein records of an Investor's vote or an Investor's accesses to information are electronically forwarded to the Issuer.

21. The method of claim 18, wherein the information includes EDGAR filings of the Issuer obtained by the electronic dissemination and tabulation system from the SEC database.

22. The method of claim 18, wherein the electronic dissemination and tabulation system is used to e-mail the investor system to inform the Investor of the event.

23. A method for online tender/exchange offers to Investors comprising the aspects of:
an Issuer of investment securities, or an agent thereof, notifying an electronic dissemination and tabulation provider of a tender/exchange event;
the electronic dissemination and tabulation provider capturing data from an E-broker system on Investors of the issuer;
Investors of the Issuer using the E-broker system to mail notice of the tender/exchange event; and
the Investors using a website of the E-broker system to tender/exchange their securities in the Issuer.

24. The method of claim 23, wherein each Investor uses an investor system to connect to the electronic dissemination and tabulation system from the website.

25. The method of claim 23, wherein responses of the Investors to the tender/exchange event are electronically forwarded to the E-broker system.

26. The method of claim 23, wherein the tender/exchange offer includes information from the SEC database obtained by the electronic dissemination and tabulation system.

27. The method of claim 24, wherein the electronic dissemination and tabulation system e-mails the investor system regarding the event.

28. A method for online delivery of Issuer information comprising the aspects of:
an Issuer of investment securities, or an agent thereof, notifying an electronic dissemination and tabulation provider of event information for Investors who trade on-line with at least one E-broker system; and
the Investors using investor systems to connect to an electronic dissemination and tabulation provider via a website of the at least one E-broker system to receive the event information.

29. The method of claim 28, wherein the Investors using investor systems securely connect to the electronic dissemination and tabulation provider from a website of the E-broker system.

30. The method of claim 28, wherein confirmation of an investor system accessing event information is electronically forwarded to the issuer.

31. The method of claim 28, wherein the electronic dissemination and tabulation provider e-mails the investor system regarding the event.

32. A method for online information gathering from Investors comprising the aspects of:
the Investors using an investor system to connect to an electronic dissemination and tabulation system via a website of at least one E-broker system; and
the electronic dissemination and tabulation system remotely administers online delivery of materials to the Investors which have been authenticated into the E-broker's website, and processes related instructions related to the materials, without the Investors leaving the E-broker's website.

33. The method of claim 32, wherein confirmation of an investor system accessing information regarding the event is electronically forwarded to the issuer.

34. The method of claim 32, wherein the electronic dissemination and tabulation system e-mails the investor system regarding the event.
